(19) United States
(12) Patent Application Publication
(10) Pub. No.: US 2017/0208662 A1
(43) Pub. Date: Jul. 20, 2017

(54) CONTROLLING LIGHT ATTRIBUTES THROUGH SHIFTS AND ROTATIONS

(71) Applicant: PHILIPS LIGHTING HOLDING B.V., EINDHOVEN (NL)

(72) Inventors: Vincentius Paulus BUIL, EINDHOVEN (NL); Lucas Jacobus Franciscus GEURTS, EINDHOVEN (NL); Bartel Marinus VAN DE SLUIS, EINDHOVEN (NL); Roel Peter Geert CUPPEN, EINDHOVEN (NL); Abraham Antonius Arnoldus BOS, EINDHOVEN (NL); Berent Willem MEERBEEK, EINDHOVEN (NL)

(73) Assignee: Philips Lighting Holding B.V., Eindhoven (NL)

(21) Appl. No.: 15/326,619

(22) PCT Filed: Jul. 15, 2015
(86) PCT No.: PCT/EP2015/066173

§ 371 Date: Jan. 16, 2017

(30) Foreign Application Priority Data
Jul. 17, 2014 (EP) 14177460.4

(51) Int. Cl. H05B 33/08; H01H 25/06

(52) U.S. Cl. CPC H05B 33/0863; H01H 25/06

(57) ABSTRACT

Devices for controlling attributes of light comprise first arrangements (1) with axes (11), second arrangements (2) shiftable in directions of the axes (11) and rotatable in planes (12) substantially perpendicular to the axes (11), and controllers (3) for in response to the shifts (21) and rotations (22) controlling first and second attributes of the light. The first and second attributes may be attributes of already activated light, such as intensities and colors. The second arrangements (2) may at least partly surround cross sections of the first arrangements (1). The first or second arrangements (1, 2) may comprise terminals (41-48). A current path (34) between at least some of the terminals (41-48) may comprise first and second sections situated at the first and second arrangements (1, 2). One or more of the first and second arrangements (1, 2) may comprise resistive material (31). The controllers (3) may control at least one of the first and second attributes in response to determinations of values of resistances of the current path (34).

### FIELD OF THE INVENTION

The invention relates to a device for controlling attributes of light. The invention further relates to a lamp comprising a device. Examples of such a device are user interfaces.

### BACKGROUND OF THE INVENTION

Traditional lighting devices support limited control options, such as turning a lighting device on or off. User interfaces for such traditional lighting devices have been designed with these limited control options in mind, for example wall switches, toggle buttons, pedal switches. Modern lighting devices allow a user to control multiple variables of the light emitted, such as the intensity of the light emitted and the color of the light emitted. While user interfaces for traditional devices can in some cases be adapted to integrate control of these multiple variables in the existing design, this provides a degraded user experience. There is a need to provide easy and intuitive devices for controlling light attributes.

JP 2011 171179 discloses controlling an intensity and a color of light by shifting a knob and by rotating this knob.

DE 32 34 131 A1 discloses a device for illuminating stages and other presentation stages with light of changing color.

### SUMMARY OF THE INVENTION

It is an object of the invention to provide an improved device. It is a further object of the invention to provide a lamp comprising an improved device.

According to a first aspect, a device is provided for controlling attributes of light, the device comprising

a first arrangement with an axis,

a second arrangement shiftable in the direction of the axis and rotatable in a plane substantially perpendicular to the axis, and

a controller for in response to a shift of the second arrangement controlling a first attribute of the light and for in response to a rotation of the second arrangement controlling a second attribute of the light different from the first attribute, at least one of the first and second arrangements comprising terminals, and a current path between at least some of the terminals comprising a first section situated at the first arrangement and a second section situated at the second arrangement.

The device comprises a first arrangement having an axis and comprises a second arrangement that can be shifted in the direction of the axis and that can at least partly be rotated in a plane substantially perpendicular to the axis. The device further comprises a controller for controlling first and second attributes of the light. In response to a shift of the second arrangement with respect to the first arrangement, the first attribute of the light is controlled. In response to a rotation of the second arrangement with respect to the first arrangement, the second attribute of the light is controlled. Terminals and a current path between at least some of the terminals, which current path comprises a first section situated at the first arrangement and a second section situated at the second arrangement, are used to analyze the shifts and the rotations.

The control of attributes of light through shifts in a direction of an axis and through rotations in a plane perpendicular to that same axis is more user-friendly than the control defined in the prior art. As a result, an improved device has been created.

A plane is substantially perpendicular to an axis in case the plane makes an angle of 60° to 120° with the axis, preferably 70° to 110°, more preferably 80° to 100°, most preferably 90°. A shift may be a straight movement in the form of a straight line. A rotation may be a circular movement in the form of a circle such as a part of a circle, a circle or more than a circle.

JP 2014 002942 discloses controlling an intensity and a color of light through shifts and rotations all in a same plane on a touch panel.

An embodiment of the device is defined by the first and second attributes being attributes of already activated light. Preferably, the attributes of already activated light comprise parameters of that already activated light.

An embodiment of the device is defined by the second arrangement at least partly surrounding a cross section of the first arrangement. Preferably, to allow the second arrangement to be rotatable in the plane substantially perpendicular to the axis of the first arrangement, the second arrangement should at least partly surround a cross section of the first arrangement.

An embodiment of the device is defined by at least one of the first and second arrangements comprising resistive material, and the controller being configured to control at least one of the first and second attributes in response to a determination of a value of a resistance of the current path. This way, the shifts and the rotations can be analyzed in many different ways, as defined below.

An embodiment of the device is defined by the terminals comprising several first terminals and several second terminals in an alternating combination situated at one of the first and second arrangements, each first terminal being connected to a resistive strip, and each second terminal being connected to a resistive or conductive strip, the strips being substantially parallel strips, the other one of the first and second arrangements comprising a resistive or conductive interconnection for coupling two subsequent strips, and the controller being configured to scan two subsequent terminals for a presence of the interconnection and, if present, to determine the value of the resistance present between the two subsequent terminals. This is a first manner to analyze the shifts and the rotations. Several first terminals are connected to resistive strips and several second terminals are connected to resistive or conductive strips. All can be situated at the first arrangement in an alternating combination. A resistive or conductive interconnection for coupling two subsequent strips can be situated at the second arrangement. Those first and second terminals, that are coupled to each other via their strips and the interconnection, represent an amount of rotation, and a value of a resistance present between these first and second terminals represents an amount of shift. Preferably, the resistive or conductive interconnection is a conductive interconnection. An opposite solution wherein the locations are interchanged is possible too.

An embodiment of the device is defined by the terminals comprising a first terminal and a second terminal situated at one of the first and second arrangements, the first terminal being coupled to the second terminal via a group of resistive strips, the strips being substantially parallel strips, ends of a first strip being coupled to the first terminal and to an end of a second strip, ends of a last strip being coupled to the second terminal and to an end of a one-but-last strip, a strip located closer to the second terminal showing a higher resistance than a strip located closer to the first terminal, the other one of the first and second arrangements comprising a resistive or conductive interconnection for coupling two subsequent strips, and the controller being configured to determine the value of the resistance present between the first and second terminals. This is a second manner to analyze the shifts and the rotations that, compared to the first manner, does no longer need the scanning of many terminals. The first and second terminals are coupled to each other via a group of resistive strips that form one serial path and that show, from the first terminal to the second terminal, a higher resistance, for example ten times higher, per subsequent strip. All can be situated at the first arrangement. A resistive or conductive interconnection for bridging parts of two subsequent strips can be situated at the second arrangement. A value of a resistance present between these first and second terminals represents an amount of rotation and an amount of shift. Preferably, the resistive or conductive interconnection is a conductive interconnection. An opposite solution wherein the locations are interchanged is possible too.

An embodiment of the device is defined by the terminals comprising a first terminal and a second terminal situated at one of the first and second arrangements, the first terminal being coupled to a first end of a first resistive strip, ends of a third resistive strip being coupled to a second end of the first resistive strip and to a first end of a fifth resistive strip, the second terminal being coupled to second and fourth resistive or conductive strips, the second resistive or conductive strip being situated between the first and third resistive strips, the fourth resistive or conductive strip being situated between the third and fifth resistive strips, the strips being substantially parallel strips, the other one of the first and second arrangements comprising a resistive or conductive interconnection for coupling two subsequent strips, and the controller being configured to determine the value of the resistance present between the first and second terminals. This is a third manner to analyze the shifts and the rotations that, compared to the second manner, does no longer need a wide range in resistance values. The first terminal is coupled to one serial path of first, third and fifth resistive strips etc. of equal resistances and the second terminal is coupled to second and fourth resistive or conductive strips etc. situated between the first and third and third and fifth resistive strips respectively. All can be situated at the first arrangement. A resistive or conductive interconnection for coupling two subsequent strips can be situated at the second arrangement. A value of a resistance present between these first and second terminals represents an amount of rotation and an amount of shift. Preferably, the resistive or conductive strips are conductive strips. An opposite solution wherein the locations are interchanged is possible too.

An embodiment of the device is defined by the terminals comprising a first terminal and a second terminal situated at one of the first and second arrangements, the first terminal being coupled to a first end of a first resistive strip, the second terminal being coupled to a first end of a second resistive or conductive strip, the strips being substantially parallel strips, the other one of the first and second arrangements comprising resistive patches for coupling the strips, each patch showing a resistance different from the resistances of the other patches and each patch only coupling the strips when the other patches do not, and the controller being configured to determine the value of the resistance present between the first and second terminals. This is a fourth manner to analyze the shifts and the rotations that, compared to the third manner, requires fewer strips. The first terminal is coupled to a first end of a first resistive strip and the second terminal is coupled to a first end of a second resistive or conductive strip. All can be situated at the first arrangement. Resistive patches for coupling the strips, each patch showing a resistance different from the resistances of the other patches, can be situated at the second arrangement. A value of a resistance present between these first and second terminals represents an amount of rotation and an amount of shift. Preferably, a resistance of the resistive strip is smaller than a minimum difference in resistance between any two patches, the resistive or conductive strip is a conductive strip, and each patch only couples the strips when the other patches do not. An opposite solution wherein the locations are interchanged is possible too.

Alternatively to the embodiments based on a use of a current path, another embodiment is possible based on a use of a contactless communication, such as for example an optical communication. However, such a contactless communication may require an energy source in the second arrangement or a supply of energy to the second arrangement in a contactless or contacting manner.

An embodiment of the device is defined by the respective first and second attributes comprising a respective intensity and color of the light or vice versa. Other possible first and second attributes are first and second light effects such as a dynamic amplitude and a dynamic frequency/period, and such as a category and a scene per category etc.

An embodiment of the device is defined by the first arrangement comprising a an oblong object, the axis being a length axis of the oblong object. An oblong object may be a pole or a tube etc. and may have a straight shape or a bended shape and may be rigid or flexible. The length axis may then be a straight axis or a bended axis.

An embodiment of the device is defined by the second arrangement comprising a ring that is rotatable around the first arrangement. A ring may have any outer shape. Alternatively and/or in addition, the second arrangement may comprise an inner ring shiftable in a direction of the axis and an outer ring rotatable around the inner ring. Or, the second arrangement may comprise the outer ring, with the first arrangement comprising the inner ring in combination with for example an oblong object. Alternatively, the ring is shiftable in a direction of the axis and a combination of the ring and the first arrangement is rotatable around the axis.

An embodiment of the device is defined by further comprising

a driver controlled by the controller for driving a light source.

Alternatively, at least one of the first and second arrangements may comprise contactless sensing components, and the controller may be configured to control at least one of the first and second attributes in response to a result derived via the contactless sensing components. Such contactless sensing components may comprise optical, magnetic, capacitive and/or inductive technology.

According to a second aspect, a lamp is provided comprising the device as defined above. The lamp may further comprise the driver and/or the light source.

A basic idea is that attributes of light should be controlled through shifts in a direction of an axis and through rotations in a plane perpendicular to that same axis.

A problem to provide an improved device has been solved. A further advantage is that the improved device allows lamps to be designed with smaller controlling protrusions or without any controlling protrusions at all.

These and other aspects of the invention will be apparent from and elucidated with reference to the embodiments described hereinafter.

### BRIEF DESCRIPTION OF THE DRAWINGS

In the drawings:

FIG. 1 shows a schematic embodiment of a lamp,

FIG. 2 shows a first embodiment of a device,

FIG. 3 shows a first schematic embodiment of arrangements,

FIG. 4 shows a second schematic embodiment of arrangements,

FIG. 5 shows a third schematic embodiment of arrangements,

FIG. 6 shows a fourth schematic embodiment of arrangements,

FIG. 7 shows a fifth schematic embodiment of arrangements,

FIG. 8 shows a sixth schematic embodiment of arrangements,

FIG. 9 shows a seventh schematic embodiment of arrangements,

FIG. 10 shows a second embodiment of a device,

FIG. 11 shows a third embodiment of a device, and

FIG. 12 shows a fourth embodiment of a device.

### DETAILED DESCRIPTION OF EMBODIMENTS

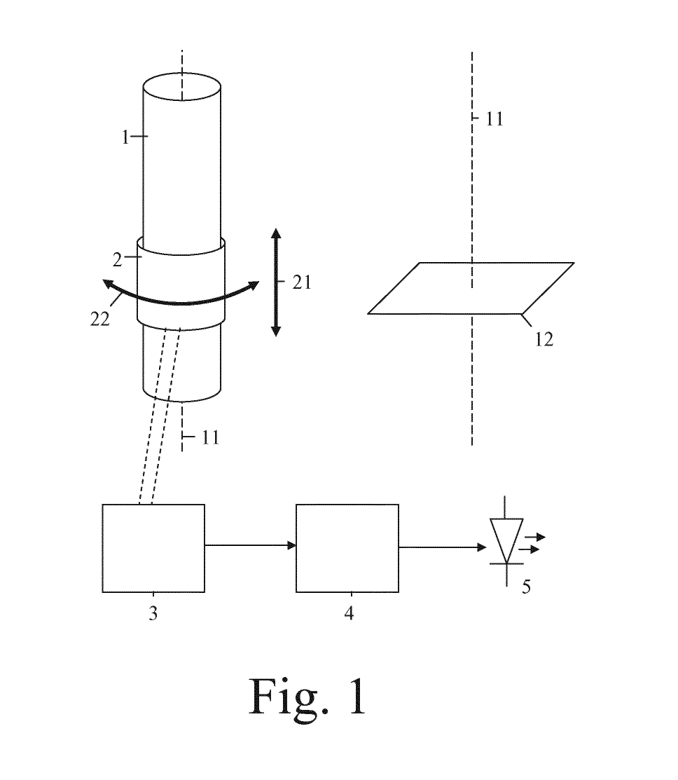

In the FIG. 1, a schematic embodiment of a lamp is shown. The lamp comprises a device for controlling attributes of light. The device comprises a first arrangement 1 with an axis 11, which axis 11 is also shown, for the sake of clarity, right from the first arrangement 1. The device comprises a second arrangement 2 shiftable in a direction of the axis 11 and rotatable in a plane 12 substantially perpendicular to the axis 11, which plane 12 is only shown, for the sake of clarity, right from the second arrangement 2. The device comprises a controller 3 for in response to a shift 21 such as a mechanical shift of the second arrangement 2 along the axis 11 controlling a first attribute of the light and for in response to a rotation 22 such as a mechanical rotation of the second arrangement 2 around the axis 11 in the plane 12 controlling a second attribute of the light different from the first attribute. The device may further comprise a driver 4 controlled by the controller 3 for driving a light source 5 such as for example one or more light emitting diodes. The lamp may further comprise the light source 5. The driver 4 may alternatively form part of the lamp.

Preferably, the first and second attributes are attributes of already activated light, and the second arrangement 2 at least partly surrounds a cross section of the first arrangement 1. The respective first and second attributes may for example comprise a respective intensity and color of the light, or vice versa. The first arrangement 1 may for example comprise an oblong object, with the axis 11 being a length axis of the oblong object. Such an oblong object may be a pole of a lamp, with the light source 5 being located at an end of this pole. The second arrangement 2 may for example comprise a ring that is rotatable around the first arrangement 1. The controller 3 may be a controlling circuit, and the driver 4 may be a driving circuit, alternatively one circuit may be presented comprising a controlling part and a driving part.

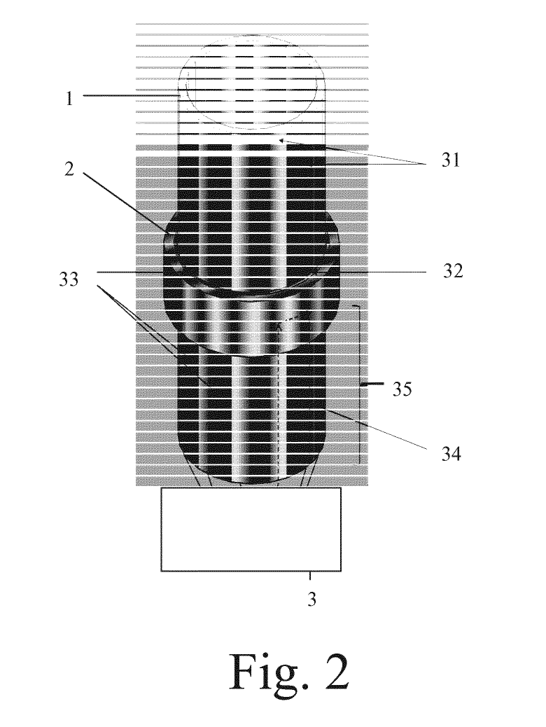

In the FIG. 2, a first embodiment of a device is shown. The device comprises the first arrangement 1 and the second arrangement 2 and the controller 3. The first arrangement 1 comprises resistive material 31 in the form of strips separated by isolative material 33. The second arrangement 2 comprises conductive material 32 and isolative material 33. The conductive material 32 interconnects two subsequent strips to create a current path 34. As a result, the current path 34 has a first section situated at the first arrangement 1 and a second section situated at the second arrangement 2. A length 35 of a side of this current path 34 determines a value of a resistance of this current path. The controller 3 is configured to control at least one of the first and second attributes in response to a determination of the value of the resistance of the current path 34.

Alternatively, of all strips, only the odd ones may comprise resistive material, and the even ones may then comprise conductive material, or vice versa.

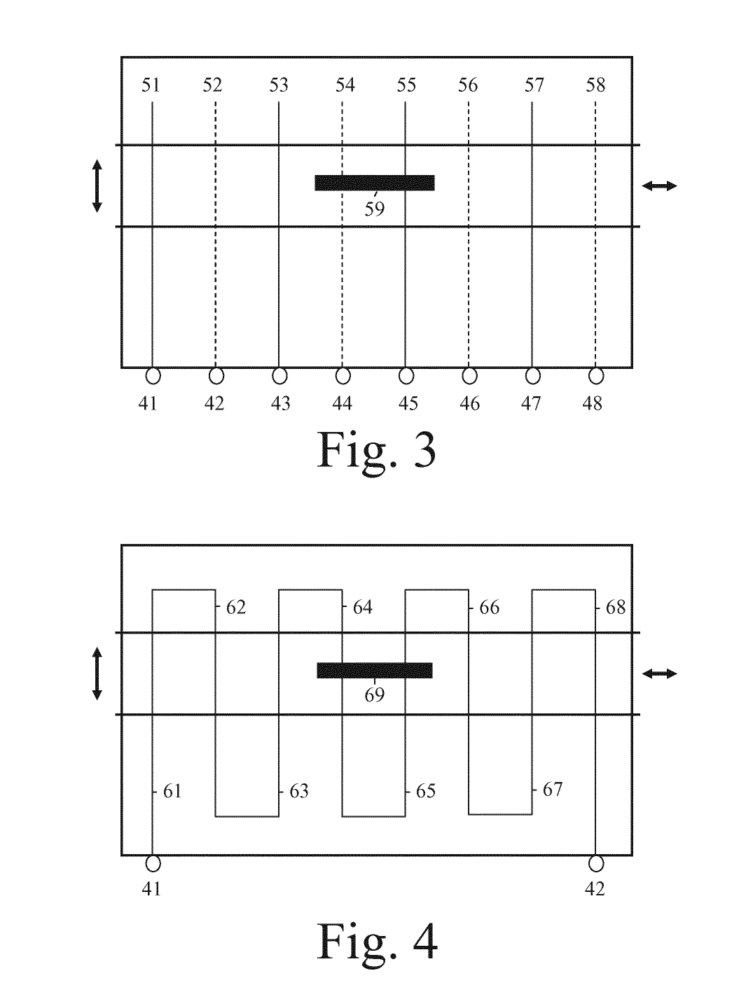

In the FIG. 3, a first schematic embodiment of the arrangements is shown. The first arrangement comprises terminals 41-48. The terminals 41-48 comprise several first terminals 41, 43, 45, 47 and several second terminals 42, 44, 46, 48 in an alternating combination. Each first terminal 41, 43, 45, 47 is connected to a resistive strip 51, 53, 55, 57 (resistive material). Each second terminal 42, 44, 46, 48 is connected to a conductive strip 52, 54, 56, 58. The strips 51-58 are parallel strips. The second arrangement 2 comprises a conductive interconnection 59 (conductive material) for coupling two subsequent (neighboring) strips 51-58. The controller 3 is here configured to scan two subsequent terminals 41-48 for a presence of the interconnection 59 and, if present, to determine the value of the resistance present between the two subsequent terminals 41-48.

As an example only, in case each resistive strip 51, 53, 55, 57 is made of material having a resistance of 100Ω per cm and each strip has a length of 10 cm, between the ends of each resistive strip 51, 53, 55, 57 there will be a resistance of 1 kΩ. An amount of resistance measured between two subsequent terminals 41-48 represents an amount of shift and said two subsequent terminals 41-48 represent an amount of rotation.

In the FIG. 4, a second schematic embodiment of the arrangements is shown. The first arrangement comprises terminals 41, 42. The terminals 41, 42 comprise a first terminal 41 and a second terminal 42. The first terminal 41 is coupled to the second terminal 42 via a group of resistive strips 61-68 (resistive material). These strips 61-68 are parallel strips and form a long path. Ends of a first strip 61 are coupled to the first terminal 41 and to an end of a second strip 62. Ends of a last strip 68 are coupled to the second terminal 42 and to an end of a one-but-last strip 67 etc. Couplings between the strips 61-68 may be other resistive strips or conductive strips etc. A strip 61-68 located closer to the second terminal 42 should show a (preferably ten times) higher resistance than a neighboring strip located closer to the first terminal 41. This should be true for each strip 61-68. The second arrangement 2 comprises a conductive interconnection 69 (conductive material) for bridging parts of two subsequent (neighboring) strips 61-68. The controller is configured to determine the value of the resistance present between the first and second terminals 41, 42.

As an example only, in case the first resistive strip 61 is made of material having a resistance of 0.1Ω per cm and it has a length of 10 cm, between the ends of the first resistive strip 61 there will be a resistance of 1Ω. In case the second resistive strip 62 is made of material having a resistance of 1Ω per cm and it has a length of 10 cm, between the ends of the second resistive strip 62 there will be a resistance of 10Ω. In case the third resistive strip 63 is made of material having a resistance of 10Ω per cm and it has a length of 10 cm, between the ends of the third resistive strip 63 there will be a resistance of 100Ω. In case the fourth resistive strip 64 is made of material having a resistance of 100Ω per cm and it has a length of 10 cm, between the ends of the fourth resistive strip 64 there will be a resistance of 1 kΩ. In case the fifth resistive strip 65 is made of material having a resistance of 1 kΩ per cm and it has a length of 10 cm, between the ends of the fifth resistive strip 65 there will be a resistance of 10 kΩ. In case the sixth resistive strip 66 is made of material having a resistance of 10 kΩ per cm and it has a length of 10 cm, between the ends of the sixth resistive strip 66 there will be a resistance of 100 kΩ. In case the seventh resistive strip 67 is made of material having a resistance of 100 kΩ per cm and it has a length of 10 cm, between the ends of the seventh resistive strip 67 there will be a resistance of 1 MΩ. And in case the eighth resistive strip 68 is made of material having a resistance of 1 MΩ per cm and it has a length of 10 cm, between the ends of the eighth resistive strip 68 there will be a resistance of 10 MΩ. An amount of resistance measured between the first and second terminals 41, 42 represents an amount of shift as well as an amount of rotation, owing to the fact that bridging different parts of two subsequent strips 61-68 will always result in different (unique) resistance values between the first and second terminals 41, 42.

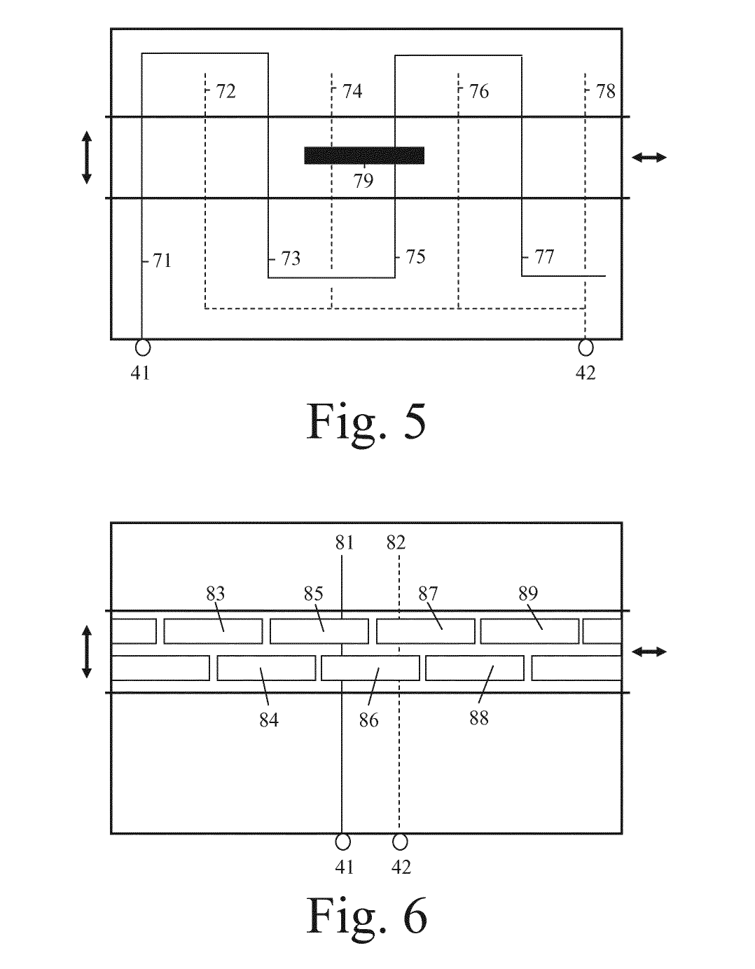

In the FIG. 5, a third schematic embodiment of arrangements is shown. The first arrangement comprises terminals 41, 42. The terminals 41, 42 comprise a first terminal 41 and a second terminal 42. The first terminal 41 is coupled to a first end of a first resistive strip 71. Ends of a third resistive strip 73 are coupled to a second end of the first resistive strip 71 and to a first end of a fifth resistive strip 75. A second end of the fifth resistive strip 75 is coupled to a first end of a seventh resistive strip 77 etc. Couplings between the strips 71, 73, 75, 77 (resistive material) may be other resistive strips or conductive strips etc. The second terminal 42 is coupled to second and fourth and sixth and eighth conductive strips 72, 74, 76, 78. The second conductive strip 72 is situated between the first and third resistive strips 71, 73. The fourth conductive strip 74 is situated between the third and fifth resistive strips 73, 75. The sixth conductive strip 76 is situated between the fifth and seventh resistive strips 75, 77. The eighth conductive strip 78 is situated next to the seventh resistive strip 77 etc. The strips 71-78 are parallel strips. The second arrangement comprises a conductive interconnection 79 (conductive material) for coupling two subsequent (neighboring) strips 71-78. The controller 3 is configured to determine the value of the resistance present between the first and second terminals 41, 42.

As an example only, in case each one of the first, third, fifth and seventh resistive strips 71, 73, 75, 77 is made of material having a resistance of 1Ω per cm and each one has a length of 10 cm, between the ends of each one of them there will be a resistance of 10Ω. An amount of resistance measured between the first and second terminals 41, 42 represents an amount of shift as well as an amount of rotation, owing to the fact that coupling two subsequent strips 71-78 at different locations will always result in different (unique) resistance values between the first and second terminals 41, 42.

In the FIG. 6, a fourth schematic embodiment of arrangements is shown. The first arrangement comprises terminals 41, 42. The terminals 41, 42 comprise a first terminal 41 and a second terminal 42. The first terminal 41 is coupled to a resistive strip 81 (resistive material). The second terminal 42 is coupled to a conductive strip 82. The strips 81, 82 are parallel strips. The second arrangement comprises resistive patches 83-89 (resistive material) for coupling the strips 81, 82. Each patch 83-89 shows a resistance different from the resistances of the other patches and each patch 83-89 only couples the strips 81, 82 when the other patches do not. The controller 3 is configured to determine the value of the resistance present between the first and second terminals 41, 42.

As an example only, in case the first resistive strip 81 is made of material having a resistance of 0.9Ω per cm and has a length of 10 cm, between the ends of it there will be a resistance of 9Ω. The respective resistive patches 83-89 for example have respective resistance values of 10Ω, 20Ω, 30Ω, 40Ω, 50Ω, 60Ω, 70Ω, each time between a left part and a right part of the patch. Preferably, the first patch 83 has a resistance value larger than a total resistance of the first resistive strip 81, and an intermediate patch 86 has a resistance value larger than a sum of a total resistance of the first resistive strip 81 and the resistance values of the foregoing patches 83-85 etc. An amount of resistance measured between the first and second terminals 41, 42 represents an amount of shift as well as an amount of rotation, owing to the fact that coupling the strips 81, 82 at different locations via different patches 83-89 will always result in different (unique) resistance values between the first and second terminals 41, 42.

Usually, two strips are substantially parallel strips in case they do not cross/touch each other over their full length. Preferably, two strips are substantially parallel strips in case their angle <30°, more preferably <20°, yet more preferably <10°, most preferably 0°. Usually, the parallel strips will also be parallel to the axis, but alternatively they may have a spiral shape around the axis. A controller may for example comprise a converter for converting (FIG. 3) resistance values and terminals into control values destined for the driver to control the attributes or for converting (FIG. 4-6) resistance values into control values destined for the driver to control the attributes.

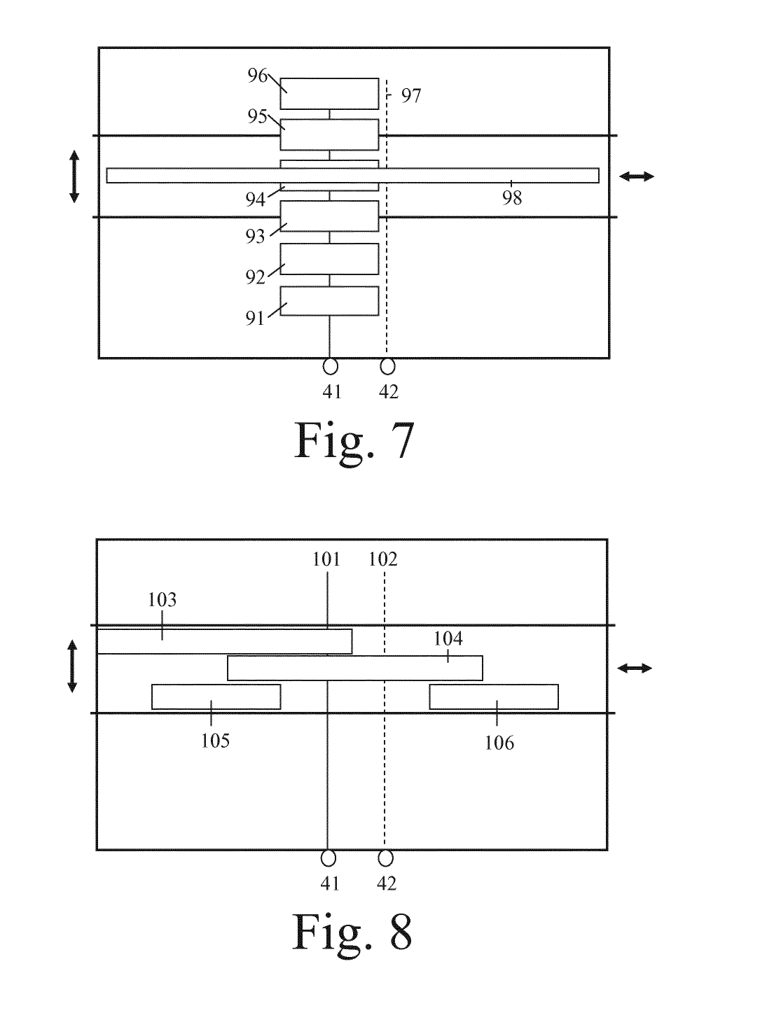

In the FIG. 7, a fifth schematic embodiment of arrangements is shown. The first arrangement comprises terminals 41, 42. The terminals 41, 42 comprise a first terminal 41 and a second terminal 42. The first terminal 41 is coupled to interconnected resistive patches 91-96 (resistive material). The second terminal 42 is coupled to a conductive strip 97. The second arrangement comprises a resistive strip 98 (resistive material) for coupling one of the patches 91-96 and the conductive strip 97. The resistive strip 98 has a resistance per length unit that changes over its length. Each patch 91-96 shows a resistance different from the resistances of the other patches, in which the difference in resistance between the patches is preferably at least as large as the range of resistance covered by the resistive strip 98. The controller 3 is configured to determine the value of the resistance present between the first and second terminals 41, 42.

In the FIG. 8, a sixth schematic embodiment of arrangements is shown. The first arrangement comprises terminals 41, 42. The terminals 41, 42 comprise a first terminal 41 and a second terminal 42. The first terminal 41 is coupled to a resistive strip 101 (resistive material). Preferably, the resistive strip 101 has a resistance per length unit that changes over its length. The second terminal 42 is coupled to a conductive strip 102. The second arrangement comprises resistive patches 103-106 (resistive material) for coupling the resistive strip 101 and the conductive strip 102. Each patch 103-106 shows a resistance different from the resistances of the other patches. As an example only, in case the resistive strip 101 is made of a material having a resistance of 0.9Ω per cm and has a length of 10 cm, between the ends of it there will be a resistance of 9Ω. The respective resistive patches 103 and 104 for example have respective resistance values of 10Ω and 20Ω and the resistive patches 105 and 106 for example each have a resistance value of 40Ω. The locations of the patches 103-106 are for example at a first level 11110000 with 1111 being the first patch 103, at a second level 00111100 with 1111 being the second patch 104, and at a third level 01100110 with 11 and 11 being the patches 105 and 106 respectively (known in the art as Gray encoding). The controller 3 is configured to determine the value of the resistance present between the first and second terminals 41, 42.

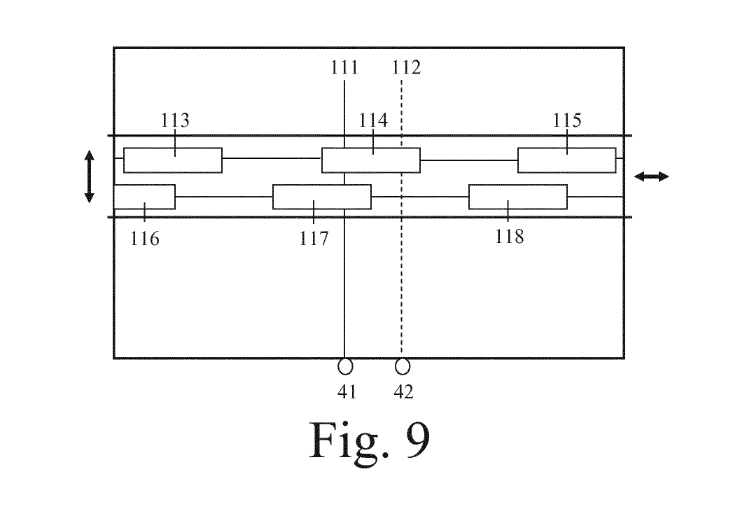

In the FIG. 9, a seventh schematic embodiment of arrangements is shown. The first arrangement comprises terminals 41, 42. The terminals 41, 42 comprise a first terminal 41 and a second terminal 42. The first terminal 41 is coupled to a resistive strip 111 (resistive material). Preferably, the resistive strip 111 has a resistance per length unit that changes over its length. The second terminal 42 is coupled to a conductive strip 112. The second arrangement comprises interconnected resistive patches 113-115 at a first level and interconnected resistive patches 116-118 at a second level (resistive material) for coupling the resistive strip 111 and the conductive strip 112. Each patch 113-115 shows a same first resistance, and each patch 116-118 shows a same second resistance different from the first resistance. As an example only, in case the resistive strip 101 is made of material having a resistance of 0.9Ω per cm and has a length of 10 cm, between the ends of it there will be a resistance of 9Ω. The respective resistive patches 113-115 and 116-118 for example have respective resistance values of 10Ω and 20Ω. The locations of the patches 113-115 are for example at a first level 110011001100 with 11 being the patches 113-115, and at a second level 011001100110 with 11 being the patches 116-118 (known in the art as quadrature encoding). The controller 3 is configured to determine the value of the resistance present between the first and second terminals 41, 42, whereby, in this case, the rotational information is no longer absolutely available (as is the case for the first to sixth schematic embodiments) but is only relatively available. The latter is also known as incremental coding and the controller 3 should be able to remind what has happened in the past.

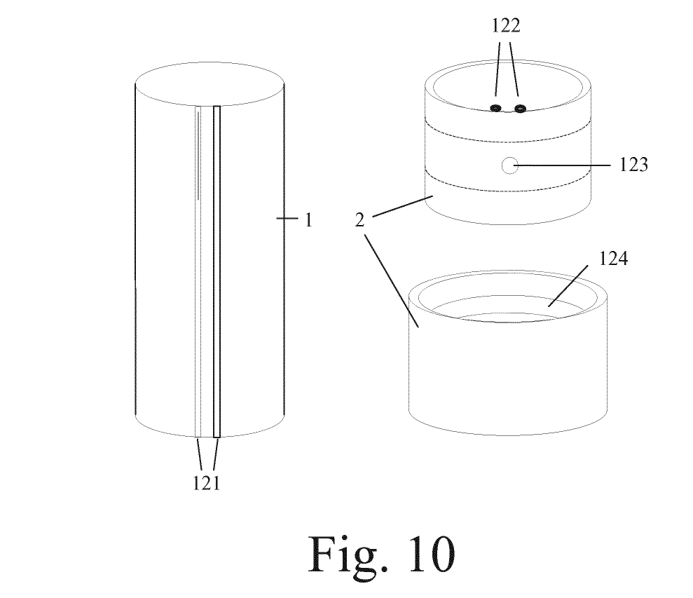

In the FIG. 10, a second embodiment of a device is shown. This device comprises a first arrangement 1 in the form of a cylinder and a second arrangement 2 in the form of an inner ring and an outer ring. The inner ring can be shifted along the cylinder and the outer ring can be rotated around the inner ring. The cylinder may comprise one or more resistive and/or conductive strips 121 for determining a shift of the rings and/or for supplying power to the inner ring, and the inner ring may be configured to determine a shift with respect to the cylinder and/or a rotation with respect to the outer ring, not only through the current methods discussed above, but also through optical, magnetic, capacitive and inductive methods and through absolute and relative (incremental) encodings. The latter methods and encodings are themselves common in the art.

Thereto, the inner ring may comprise one or more contacts 122 for contacting the one or more strips 121 for providing power to a unit 123 such as a light emitting diode with a light dependent resistor or such as a magneto-resistive sensor or a hall-effect sensor. The unit 123 is located on the inner ring. The outer ring may comprise a strip 124 for reflecting light coming from the light emitting diode on the light dependent resistor in a location dependent way or for providing different magnetic responses in a location dependent way etc. The strips 121 may comprise rails for guiding the outer ring, and one or more of the inner and outer rings may comprise a structure to facilitate a rotation of the outer ring etc. Alternatively, power may be provided to the unit 123 in a contactless manner. A controller not shown here and in line with the controller 3 shown in the FIGS. 1 and 2 may be located anywhere.

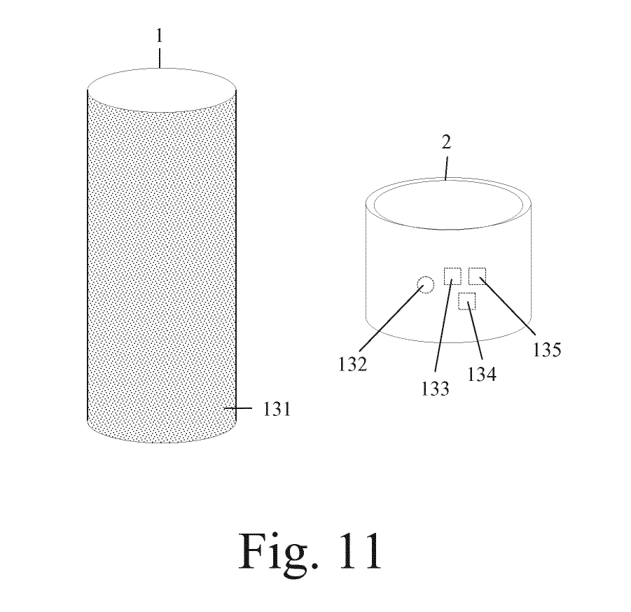

In the FIG. 11, a third embodiment of a device is shown. This device comprises a first arrangement 1 in the form of a cylinder and a second arrangement 2 in the form of a ring. The ring can be shifted along the cylinder and can be rotated around the cylinder. The cylinder may comprise a surface 131 with a pattern and the ring may comprise an optical sensor 132 for determining a shift and a rotation of the ring by observing the pattern. Instead of this optical technology, magnetic, capacitive, inductive or resistive technology may be used. The ring may further comprise a power supply 133 such as a battery or a receiver for receiving power in a contactless manner etc., a controller 134 in line with the controller 3 shown in the FIGS. 1 and 2, and a unit 135 for wireless communication with another unit located close to the light source or in a network etc.

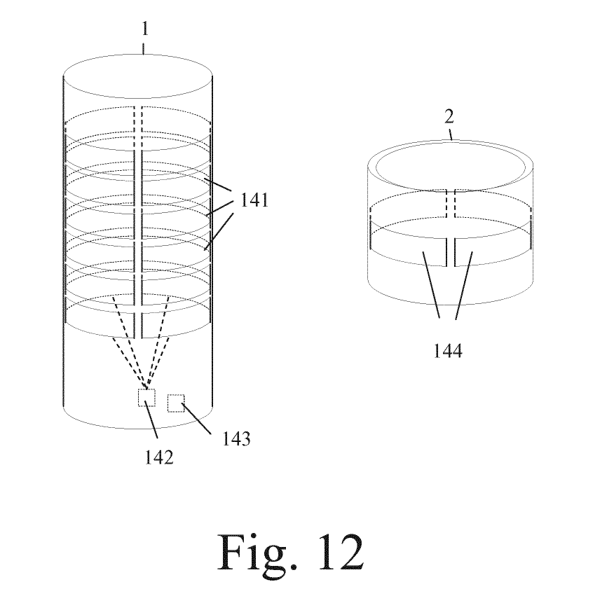

In the FIG. 12, a fourth embodiment of a device is shown. This device comprises a first arrangement 1 in the form of a cylinder and a second arrangement 2 in the form of a ring. The ring can be shifted along the cylinder and can be rotated around the cylinder. The cylinder may comprise at its inner side a grid of conductive patches 141 coupled to a capacitive proximity sensor 142 that is to be coupled to a controller 143 in line with the controller 3 shown in the FIGS. 1 and 2. The grid of conductive patches 141 could for example be printed on a flexible printed circuit board mounted inside the cylinder made of plastic or glass. The ring may comprise a line of conductive patches 144 for in response to a shift or a rotation of the ring changing a capacitance of the grid of conductive patches 141 as measured by the capacitive proximity sensor 142 such that the controller 143 can determine the shift or the rotation etc. The patches in the line of conductive patches 144 function as passive electrodes and the patches in the grid of conductive patches 141 function as active electrodes. Instead of this capacitive technology, magnetic, inductive, optical or resistive technology may be used. The capacitive proximity sensor 142 and the controller 143 may be fed via a power supply such as a battery or mains or a receiver for receiving power etc.

Compared to sensing a shift and a rotation in a contacting manner, the sensing of a shift and a rotation in a contactless manner will not be sensitive to dirt, and wear and tear. A use of a power supply in the form of mains is, compared to a battery, to be preferred. A battery may be a chargeable battery to be charged in a contacting or contactless manner. Preferably, visually observable design constraints are to be avoided. A controller may be located anywhere in a lamp.

Summarizing, devices for controlling attributes of light comprise first arrangements 1 with axes 11, second arrangements 2 shiftable in directions of the axes 11 and rotatable in planes 12 substantially perpendicular to the axes 11, and controllers 3 for in response to the shifts 21 and rotations 22 controlling first and second attributes of the light. The first and second attributes may be attributes of already activated light, such as intensities and colors. The second arrangements 2 may at least partly surround cross sections of the first arrangements 1. The first or second arrangements 1, 2 may comprise terminals 41-48. A current path 34 between at least some of the terminals 41-48 may comprise first and second sections situated at the first and second arrangements 1, 2. One or more of the first and second arrangements 1, 2 may comprise resistive material 31. The controllers 3 may control at least one of the first and second attributes in response to determinations of values of resistances of the current path 34.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A device for controlling attributes of light, the device comprising
a first arrangement with an axis,
a second arrangement shiftable in the direction of the axis and rotatable in a plane substantially perpendicular to the axis, and
a controller for in response to a shift of the second arrangement controlling a first attribute of the light and for in response to a rotation of the second arrangement controlling a second attribute of the light different from the first attribute, at least one of the first and second arrangements comprising terminals, and a current path between at least some of the terminals comprising a first section situated at the first arrangement and a second section situated at the second arrangement.

2. The device as defined in claim 1, the first and second attributes being attributes of already activated light.

3. The device as defined in claim 1, the second arrangement at least partly surrounding a cross section of the first arrangement.

4. The device as defined in claim 1, at least one of the first and second arrangements comprising resistive material, and the controller being configured to control at least one of the first and second attributes in response to a determination of a value of a resistance of the current path.

5. The device as defined in claim 4, the terminals comprising several first terminals and several second terminals in an alternating combination situated at one of the first and second arrangements, each first terminal being connected to a resistive strip, and each second terminal being connected to a resistive or conductive strip, the strips being substantially parallel strips, the other one of the first and second arrangements comprising a resistive or conductive interconnection for coupling two subsequent strips, and the controller being configured to scan two subsequent terminals for a presence of the interconnection and, if present, to determine the value of the resistance present between the two subsequent terminals.

6. The device as defined in claim 4, the terminals comprising a first terminal and a second terminal situated at one of the first and second arrangements, the first terminal being coupled to the second terminal via a group of resistive strips, the strips being substantially parallel strips, ends of a first strip being coupled to the first terminal and to an end of a second strip, ends of a last strip being coupled to the second terminal and to an end of a one-but-last strip, a strip located closer to the second terminal showing a higher resistance than a strip located closer to the first terminal, the other one of the first and second arrangements comprising a resistive or conductive interconnection for bridging parts of two subsequent strips, and the controller being configured to determine the value of the resistance present between the first and second terminals.

7. The device as defined in claim 4, the terminals comprising a first terminal and a second terminal situated at one of the first and second arrangements, the first terminal being coupled to a first end of a first resistive strip, ends of a third resistive strip being coupled to a second end of the first resistive strip and to a first end of a fifth resistive strip, the second terminal being coupled to second and fourth resistive or conductive strips, the second resistive or conductive strip being situated between the first and third resistive strips, the fourth resistive or conductive strip being situated between the third and fifth resistive strips, the strips being substantially parallel strips, the other one of the first and second arrangements comprising a resistive or conductive interconnection for coupling two subsequent strips, and the controller being configured to determine the value of the resistance present between the first and second terminals.

8. The device as defined in claim 4, the terminals comprising a first terminal and a second terminal situated at one of the first and second arrangements, the first terminal being coupled to a first end of a first resistive strip, the second terminal being coupled to a first end of a second resistive or conductive strip, the strips being substantially parallel strips, the other one of the first and second arrangements comprising resistive patches for coupling the strips, each patch showing a resistance different from the resistances of the other patches, and the controller being configured to determine the value of the resistance present between the first and second terminals.

9. The device as defined in claim 1, the respective first and second attributes comprising a respective intensity and color of the light or vice versa.

10. The device as defined in claim 1, the first arrangement comprising an oblong object, the axis being a length axis of the oblong object.

11. The device as defined in claim 1, the second arrangement comprising a ring that is rotatable around the first arrangement.

12. The device as defined in claim 1, further comprising a driver controlled by the controller for driving a light source.

13. A lamp comprising the device as defined in claim 1.
